(19) United States
(12) Patent Application Publication
(10) Pub. No.: US 2005/0002434 A1
(43) Pub. Date: Jan. 6, 2005

(54) Cooled mirror for a laser beam

(75) Inventors: Karl-Heinz Armier, Hamburg (DE); Klaus Kopke, Escheburg (DE); Jurgen Peters, Hamburg (DE)

Correspondence Address: LERNER AND GREENBERG, PA, P O BOX 2480, HOLLYWOOD, FL, 33022-2480, US

(73) Assignee: Rofin-Sinar Laser GmbH

(21) Appl. No.: 10/892,082

(22) Filed: Jul. 15, 2004

Related U.S. Application Data
(63) Continuation of application No. PCT/EP03/00396, filed on Jan. 16, 2003.

(30) Foreign Application Priority Data
Jan. 16, 2002 (DE) 102 01 334.9

(51) Int. Cl. H01S 3/08

(52) U.S. Cl. 372/99

(57) ABSTRACT

A mirror for a laser beam, in which at least one first cooling channel for a cooling fluid is disposed for cooling a zone that is thermally impinged by a laser beam. The cooling channel extends in the interior of the mirror such that the zone is cooled at least substantially symmetrically to its center and that the cooling fluid heated up in this zone is directed to thermally unaffected zones of the mirror to compensate for thermally caused stresses.

### CROSS-REFERENCE TO RELATED APPLICATION

This application is a continuation, under 35 U.S.C. § 120, of copending international application No. PCT/EP03/00396, filed Jan. 16, 2003, which designated the United States; this application also claims the priority, under 35 U.S.C. § 119, of German patent application No. 102 01334.9, filed Jan. 16, 2002; the prior applications are herewith incorporated by reference in their entirety.

### BACKGROUND OF THE INVENTION

### FIELD OF THE INVENTION

The invention relates to a mirror for a laser beam with a high power density.

Mirrors that are used to guide or shape a high-power laser beam are subject to high thermal loads on account of the high power density in the laser beam and the inevitable absorption of some of the power that strikes them. This leads first to local heating of the mirror, which over the course of operation can give rise to damage to the reflective coating. Secondly, the introduction of heat from one side causes major temperature gradients to be produced within the mirror, which gradients lead to deformation of the mirror surface and, therefore, to an undesirable change in the properties of the laser beam, i.e., its profile (shape) and its propagation direction.

To avoid deformation of this nature, it is fundamentally known to cool the corresponding mirrors with the aid of a fluid. In many applications, however, simple cooling of the mirror is insufficient to reduce deformations to an acceptable level. Rather, in addition to cooling of the mirror surface, simultaneous heating of the rear side of the mirror, remote from the mirror surface, is also required to avoid thermally induced deformation. A mirror of this type is known, for example, from U.S. Pat. No. 4,253,739 to Carlson, in which the cooling fluid that has been heated in the region of the mirror surface is guided onto the rear wall of the mirror to heat the latter and, in this way, to compensate for thermally induced deformation of the mirror surface. For such a purpose, the cooling fluid is introduced laterally into the mirror body, flows under the mirror plate to the opposite edge of the mirror, where it is guided to the rear wall and, then, flows back in the opposite direction to the outlet, which is, likewise, located at the lateral edge of the mirror. Uneven heating of the mirror surface and deformation of this surface cannot be prevented in this way, however.

Thermally induced deformation is undesirable, in particular, in the case of mirrors that are used as resonator mirrors, where deformation has a particularly disadvantageous effect because the associated deterioration in the optical properties of the resonator has a particularly sensitive effect on the properties of the laser beam emerging from the resonator. This is a problem, in particular, in the case of planar diffusion-cooled high-power CO₂ stripline lasers, as are known, for example, from U.S. Pat. No. 4,719,639, on account of the large size of the resonator mirrors, which extend over the entire width of the electrodes. With the known stripline lasers, therefore, the only mirrors that are used are those in which the introduction of heat is minimized by surfaces that are as highly reflective as possible. However, such surfaces are, generally, complex to produce. Moreover, in operation, they lose their favorable reflection properties as a result of possible soiling.

Therefore, in German Patent DE 44 28 194 C2, analogously to the mirror that is known from the above-referenced U.S. Pat. No. 4,253,739, it is proposed for the resonator mirrors of a stripline laser to be thermally coupled to a controllable heat source, for example, a heating conductor disposed on its rear side to compensate for deformation caused by the laser beam. However, in the high-power range, it has emerged that compensation of this nature is no longer sufficient, in particular, when operating with pronounced power changes, to avoid thermal deformation because the required heating power is too great and the control is insufficiently responsive.

### SUMMARY OF THE INVENTION

It is accordingly an object of the invention to provide a cooled mirror for a laser beam that overcomes the hereinafore-mentioned disadvantages of the heretofore-known devices of this general type and that in which deformation of the mirror surface resulting from the introduction of heat from one side is reduced even without the use of an additional heat source.

With the foregoing and other objects in view, there is provided, in accordance with the invention, a mirror for a laser beam, including a mirror body having a first region under thermal load from the laser beam, the region having a center, at least one second region not under thermal load from the laser beam, and at least one cooling passage compensating for thermally induced stresses in the mirror body, the at least one cooling passage being disposed to pass a cooling fluid through the mirror body and cool the first region at least approximately symmetrically with respect to the center of the first region and guiding the cooling fluid heated in the first region into the at least one second region.

According to the invention, to cool a region that is subject to thermal load from the laser beam, i.e., a region that is adjacent to the surface acted on by the laser beam, at least a first cooling passage for a cooling fluid is disposed in the interior of the mirror such that the region is cooled at least approximately symmetrically with respect to its center and the cooling fluid heated in this region is guided into regions of the mirror that are not subject to thermal loading, i.e., are not acted on by the laser beam, to compensate for thermally induced stresses.

In accordance with another feature of the invention, the mirror body has a mirror surface and a rear wall opposite the mirror surface, the cooling fluid flows in the at least one cooling passage in a direction of flow, and the at least one cooling passage has an internal first passage section disposed adjacent the first region and cooling the first region and an internal second passage section disposed downstream of the internal first passage section with respect to the direction of flow of the cooling fluid and is adjacent the rear wall.

Because the heated cooling fluid is guided into regions of the mirror that are not directly heated by the laser beam (i.e., are not subject to thermal loading), where it releases some of the heat quantity that it has taken up, temperature gradients within the mirror that cause deformation of the mirror surface, i.e., cause it to deviate from the desired geometry, can be considerably reduced combined, at the same time, with efficient cooling of the mirror without the need for a separate heating source. The invention is, therefore, based on the idea of using the cooling fluid itself, which has been heated in thermally loaded regions of the mirror, as a heating source instead of a separate heating source. The cooling fluid that has been heated as a result of heating of the thermally loaded region, therefore, serves to heat the regions of the mirror that are not subject to thermal loading and are located in zones that would lead to undesired deformation if a temperature gradient were present. The particular routing of the cooling passage into regions that are not subject to thermal loading that is expedient for the particular circumstances and also the structural configuration of the cooling passage are dependent mainly on the specific configuration of the mirror body and on the position and geometric shape of that part of the mirror surface that is acted on by the laser beam.

Because, moreover, the quantity of heat taken up by the cooling fluid, and, therefore, also the quantity of heat released by the cooling fluid at the rear side of the mirror, are directly determined by the introduction of heat caused by the laser beam, the heating of these regions of the mirror that are not subject to thermal loading required to avoid unacceptable temperature gradients will, inevitably, be matched to the prevailing operating conditions of the laser, without the need for any external control.

Moreover, the first cooling passage is disposed such that the region that is subject to thermal loading is cooled at least approximately symmetrically with respect to the center. This results in the expansion of the mirror surface retaining the correct shape and, consequently, changes to the optical properties of the mirror are avoided substantially.

In accordance with a further feature of the invention, the first cooling passage includes an internal first passage section, which is disposed adjacent to the mirror surface of the mirror and downstream of which, as seen in the direction of flow of the cooling fluid, there is an internal second passage section, which is disposed adjacent to the rear wall. Because the heated cooling fluid is guided to the rear wall of the mirror, where it releases some of the heat quantity that it has taken up, the temperature gradient between mirror surface and rear wall, which is substantially responsible for deformation of the mirror surface, is reduced considerably and, at the same time, the mirror is cooled efficiently.

In accordance with an added feature of the invention, the mirror is provided with at least one feed passage and at least one outlet passage for the cooling fluid, which are connected to the first and second passage sections, respectively, such that the cooling fluid is divided, in the first and second passage sections, into at least two partial-streams that flow from the center to the edge and from the edge to the center, respectively. Such a configuration results in symmetrical cooling of the mirror and further reduces the thermal deformation.

In accordance with an additional feature of the invention, it is preferable for the first and second passage sections to communicate with one another through at least one inner, lateral connecting passage. Such a configuration allows particularly efficient utilization of the heat quantity introduced into the cooling fluid and leads to a particularly homogenous temperature distribution in the mirror.

In particular, the first and second passage sections run substantially parallel to the mirror surface or to the rear wall, respectively. Because the passage sections substantially follow the contour of the mirror surface or rear wall, asymmetrical thermal loading is avoided substantially and thermally induced bending is, additionally, reduced.

In accordance with yet another feature of the invention, the first and second passage sections are disposed approximately mirror-symmetrically with respect to one another, at least over a substantial part of their length, with respect to a center plane running approximately parallel to the mirror surface. The mirror-symmetrical configuration of the first and second passage sections allows uniform cooling of the mirror throughout its volume and substantially reduces the occurrence of thermal stresses.

In accordance with yet a further feature of the invention, the first passage section is connected to a plurality of symmetrically disposed feed passages. As a result, fresh cooling water is supplied to the thermally loaded region at a plurality of locations, and the temperature of the mirror is made more uniform over its entire area.

In accordance with yet an added feature of the invention, the second passage section is also connected to a plurality of outlet passages so that the temperature is also made more even in the region that is heated by the second passage section.

In accordance with yet an additional feature of the invention, there is, preferably, a second cooling passage, which is of substantially the same construction as the first cooling passage, with the first and second cooling passages being disposed mirror-symmetrically with respect to a plane of symmetry, running perpendicular to the center plane, of a laser beam that impinges on the mirror surface. As a result, the available heat-exchange surface area is increased and, consequently, the efficiency of cooling is improved. In this embodiment, the mirror is suitable, in particular, for laser beams that have an elongate rectangular profile, i.e., a large dimension in an axis that is transverse with respect to the beam axis and a small dimension perpendicular thereto. The corresponding mirror then, likewise, has an approximately rectangular geometry, i.e., a large transverse extent and a low height. Moreover, particularly in applications in which the laser beam is very narrow, as is the case for a laser beam that emerges from the narrow discharge space of a stripline laser toward the resonator mirror, it is ensured that the central region of the mirror between the passage sections, i.e., a region that extends only a few millimeters beyond both sides of the plane of symmetry, is cooled uniformly so that minor de-alignments (center plane of the laser beam≠plane of symmetry of the mirror) do not lead to disruptive deformation of the mirror. Furthermore, division into two cooling passages spaced apart from one another enables the first passage sections, which, in each case, adjoin the mirror surface, to run as close as possible to the surface because a web that supports the mirror surface remains in place between the first passage sections. The number of cooling passages is not restricted to two. Rather, it is also possible to provide more than two symmetrically disposed cooling passages.

In accordance with again another feature of the invention, the mirror body has a center plane running approximately parallel to the mirror surface, a plane of symmetry running perpendicular to the center plane, and a second cooling passage having a configuration substantially the same as the at least one cooling passage, and the at least one cooling passage and the second cooling passage are disposed mirror-symmetrically with respect to the plane of symmetry.

In accordance with again a further feature of the invention, the mirror body has an internal, perpendicular connecting passage and the at least one cooling passage and the second cooling passage each communicate with one another through the internal, perpendicular connecting passage.

In accordance with again an added feature of the invention, the mirror includes a base plate and a cover plate, between which is a reflector plate that includes the mirror surface and the cooling passage(s). Such a sandwich structure enables the cooling passages to be milled into the reflector plate on both flat sides so that, in manufacturing technology terms, it is easy to match the shaping and profile of the cooling passages to the particular requirements. The cooling passage is disposed to pass a cooling fluid through the mirror body and cool the first region at least approximately symmetrically with respect to the center of the first region and guiding the cooling fluid heated in the first region into the at least one second region to compensate for thermally induced stresses in the mirror body.

In accordance with a concomitant feature of the invention, the mirror according to the invention is particularly suitable for use as a resonator mirror of a stripline laser, in particular, a CO₂ high-power stripline laser. The stripline laser has areally extending electrodes defining a discharge space therebetween, the electrodes having at least one end side, a laser gas disposed between the electrodes, and a resonator mirror disposed on the at least one end side and having the base plate, the cover plate, and the reflector plate disposed between the base plate and the cover plate.

Other features that are considered as characteristic for the invention are set forth in the appended claims.

Although the invention is illustrated and described herein as embodied in a cooled mirror for a laser beam, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic, perspective and partially hidden view of a mirror according to the invention;

FIG. 2 is a diagrammatic, plan and partially hidden view of the mirror of FIG. 1;

FIG. 3 is a diagrammatic, front elevational view of a structural configuration of a mirror according to the invention for use as a resonator mirror for a stripline laser;

FIG. 4 is a diagrammatic, plan and partially hidden view of the mirror of FIG. 3 perpendicular to a plane of propagation of the laser beam;

FIG. 5 is a diagrammatic, cross-sectional view through the mirror of FIG. 3 along section line V-V;

FIG. 6 is a diagrammatic, cross-sectional view of another embodiment of a resonator mirror for a stripline laser according to the invention;

FIG. 7 is a diagrammatic, plan view of a stripline laser with a resonator mirror according to the invention; and

FIG. 8 is a diagrammatic, side view of the stripline laser of FIG. 7.

### DESCRIPTION OF THE PREFERRED EMBODIMENTS

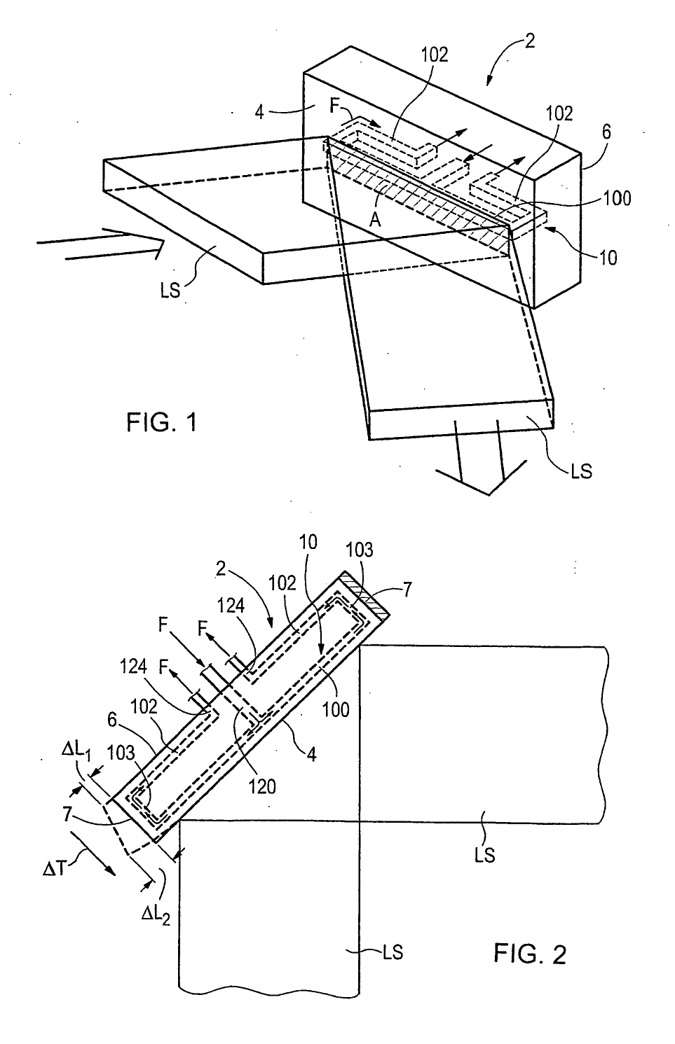

Referring now to the figures of the drawings in detail and first, particularly to FIG. 1 thereof, there is shown a laser beam LS impinging on a mirror 2 and is reflected by the mirror 2. The exemplary embodiment illustrates a laser beam LS with a rectangular beam profile and a mirror 2 with a planar mirror surface 4. The laser beam LS illuminates an area A that is indicated by hatching and at which, on account of the high intensity and the inevitable partial absorption of the laser beam LS, heat is introduced into the mirror 2 and, in the vicinity of which, the mirror is subject to thermal loading (thermally loaded region).

A first cooling passage 10, which is illustrated by dashed lines and has a cooling fluid F flowing through it, runs inside the mirror 2. The cooling passage 10 includes an inner, first passage section 100, which runs adjacent to the mirror surface 4 and downstream of which, as seen in the direction of flow of the cooling fluid F, there is an inner second passage section 102, which is routed along the rear wall 6 of the mirror 2.

Without heating of the rear wall 6, on the opposite side from the mirror surface 4, of the mirror 2, a temperature gradient would build up between mirror surface 4 and rear wall 6, leading to bending of the mirror surface 4, which bending is illustrated in FIG. 2. Introduction of heat from one side, with the resultant temperature gradient Δt, would cause the length dimension ΔL₁ of the rear wall 6 to be shorter than the length dimension ΔL₂ of the mirror surface 4, as illustrated by dashed lines in FIG. 2. These differences would, then, manifest themselves in curving of the mirror surface 4.

According to the invention, such a temperature gradient is avoided by the cooling fluid F that has been heated in the first passage section 100, as it flows through the second passage section 102, heating the rear side 6 of the mirror 2 to an extent that corresponds to its uptake of heat and, therefore, to the introduction of power on the mirror surface 4.

The cooling fluid F is supplied through a feed passage 120 approximately in the center of the mirror 2, which, generally, coincides with the center of the laser beam LS impinging on it. The cold cooling fluid F is divided into two partial-streams, that flow in immediate proximity to the mirror surface 4 and parallel thereto, in opposite directions to one another, outward toward the lateral edges 7 of the mirror 2. The cooling fluid F dissipates the heat introduced into the mirror 2 through the surface A and is gradually warmed up, resulting in a temperature drop toward the center along the mirror surface. Internal connecting passages 103 disposed at the lateral edge 7 cause the cooling fluid F to be guided to the second passage section 102, which runs along the rear wall 6. There, the cooling fluid F releases some of the heat quantity that it has taken up before being discharged from the mirror 2 through outlet passages 124 approximately in the center of the mirror 2. In the region of the rear wall 6, the cooling fluid F flows in the opposite direction to its direction of flow in the region of the mirror surface 4. As a result, the heated cooling fluid F heats the edge zone of the rear wall 6 to a greater extent than the central region so that a temperature drop toward the center is established at the rear wall 6 in the same way as at the mirror surface 4. The heating of the rear wall 6 of the mirror 2, with approximately the same temperature distribution as is present at the mirror surface, means that the mirror surface 4 and rear wall 6 of the mirror 2 expand to approximately the same extent, with internal stresses being avoided, so that bending is prevented. The compensation is illustrated in FIG. 2 by the hatched region at the right-hand edge 7 of the mirror 2.

The considerations that have been explained on the basis of FIGS. 1 and 2 can, fundamentally, also be applied to other beam profiles and curved, i.e., beam-shaping, mirror surfaces. The important factor is that the routing of the cooling fluid homogenizes the temperature distribution by the heat that is introduced on the illuminated surface not only being dissipated by the coolant but also being utilized, as a result of a suitable configuration of the cooling passage, to heat volume regions of the mirror that are not acted on by the laser beam.

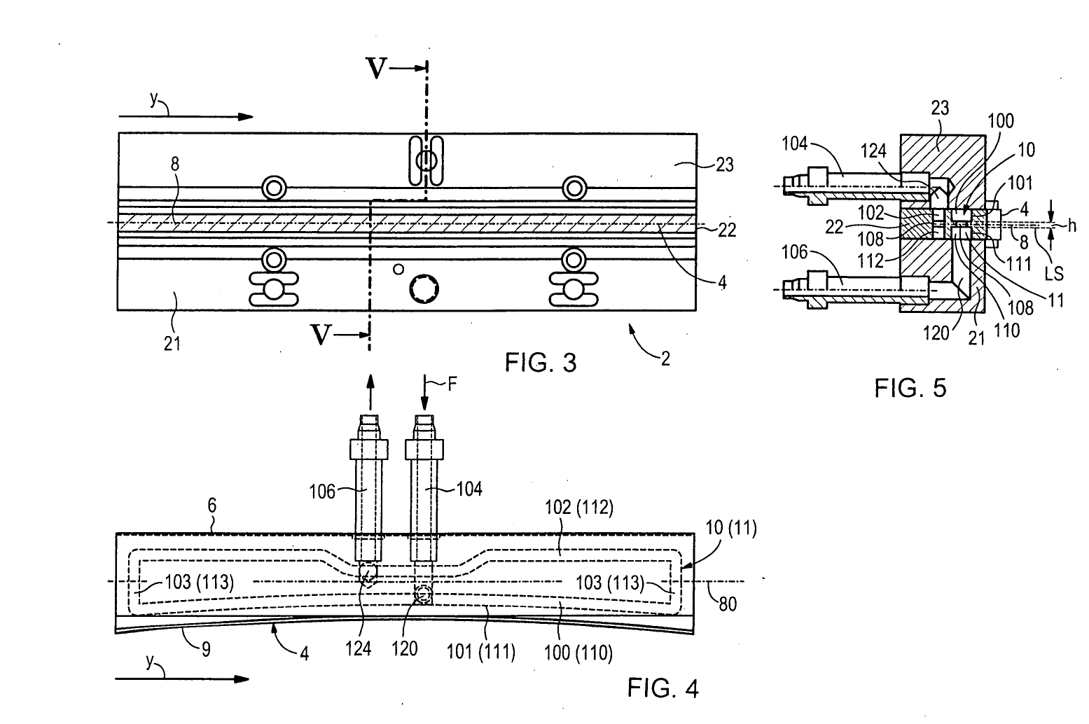

In FIG. 3, the mirror 2 is a resonator mirror of a CO₂ stripline laser and is in sandwich-like form, including a base plate 21, a reflector plate 22, and a cover plate 23, which, preferably, is of copper Cu and are soldered together. On its end side, the reflector plate 22 bears the concavely curved mirror surface 4, which is hatched in the drawing and, in the specific embodiment, is part of a paraboloid of rotation.

The first and a second cooling passage 10 and 11, respectively, the profile of which is indicated by dashed lines in the plan view shown in FIG. 4 (plane of the drawing parallel to the plane of symmetry 8), are disposed in the reflector plate 22, mirror-symmetrically with respect to their plane of symmetry 8 extending in their transverse direction y and perpendicular to the mirror surface 4. The first cooling passage 10 includes the first passage section 100, which runs as close as possible to the mirror surface 4 and extends over virtually the entire transverse dimension of the mirror 2 so that the entire mirror surface 4 that is acted on by the laser beam when a stripline laser is operating, and is, therefore, subject to thermal loading, is cooled.

The second passage section 102 is connected, through the inner, lateral connecting passages 103, to the first passage section 100 and runs substantially parallel to the rear wall 6, remote from the mirror surface 4, of the resonator mirror 6 so that the first cooling passage 10 is annular and substantially follows the outer contour of the reflector plate 22. The first and second passage sections 100, 102 are, in this case, disposed approximately mirror-symmetrically to one another with respect to a center plane 80 running approximately parallel to the mirror surface 4 and perpendicular to the plane of the drawing.

In the plan view shown in FIG. 4, the second cooling passage 11, which is of the same structure as the first cooling passage 10, with passage sections 110, 112 and connecting passages 113 that are correspondingly of the same structure, is located beneath the first cooling passage 10.

For efficient and uniform cooling of the mirror surface 4, the first passage sections 100, 110, in the transverse direction y, run parallel to the line of intersection 9 between the mirror surface 4 and the plane of symmetry 8, running parallel to the plane of the drawing, of the mirror 2 so that the wall surface 101, 111 of the passage section 100 or 110, respectively, which is in each case facing the mirror surface 4 is matched to the curvature of the latter. On account of the large radii of curvature of the mirror surface 4 (typical values in practice of the order of magnitude of approximately 1-2 m), the wall surfaces 101, 111 need not be curved in the plane perpendicular thereto.

The mirror 2 is provided at its rear wall with connection pieces 104, 106, through which the cooling fluid F is supplied and discharged.

It can be seen from the sectional illustration present in FIG. 5 that the first and second cooling passages 10, 11 in the reflector plate 22 are disposed symmetrically with respect to the plane of symmetry 8. The first and second cooling passages 10, 11 respectively communicate with one another through a perpendicular connecting passage 108. The perpendicular connecting passages 108 are located directly above the inlet passage 120 or below the outlet passages 124.

The first and second cooling passages 10, 11 have a substantially rectangular cross-sectional shape. On account of the sandwich structure of the resonator mirror 8, the cooling passages 10, 11 are simple to produce in terms of manufacturing technology, for example by milling, on the two flat sides. On account of the large radius of curvature of the mirror surface 4, the actual curvature of this mirror surface can no longer be seen in the plane of the drawing shown in FIG. 5. Since the mirror surface 4 is virtually planar in the plane of the drawing, the flat wall surface 101, 111, facing the mirror surface 4,.of the respectively adjacent passage section 100 or 110, respectively, is always parallel to the mirror surface 4 so that the latter is substantially uniformly cooled and stresses are avoided.

A solid central region of the reflector plate 22 and, therefore, of the mirror 2, extending on both sides of the plane of symmetry, is located between the first cooling passage 10 and the second cooling passage 11, which is disposed symmetrically with respect to the plane of symmetry 8 (the position of the section line V-V means that the central region cannot be seen in section in the figure). This central region forms a web that has a stabilizing effect on the mirror surface 4. Routing the cooling fluid F within the reflector plate 22 by two first passage sections 100 and 110, which are spaced apart from one another and disposed symmetrically with respect to the plane of symmetry 8, therefore, makes a significant contribution to the effective cooling of the mirror surface 4. This is advantageous, in particular, if the mirror 2 is used as the resonator mirror of a stripline laser. The extent h of the laser beam LS perpendicular to the transverse extent is, then, just a few millimeters (typically 1 to 2 mm). Uneven cooling of the mirror surface 4 would, then, cause any de-alignments or fluctuations in the beam position on the mirror surface 4 on account of the optical properties of the mirror surface 4 that are dependent on the beam position under an inhomogeneous temperature distribution, to produce a considerable fluctuation and, therefore, deterioration in the resonator properties.

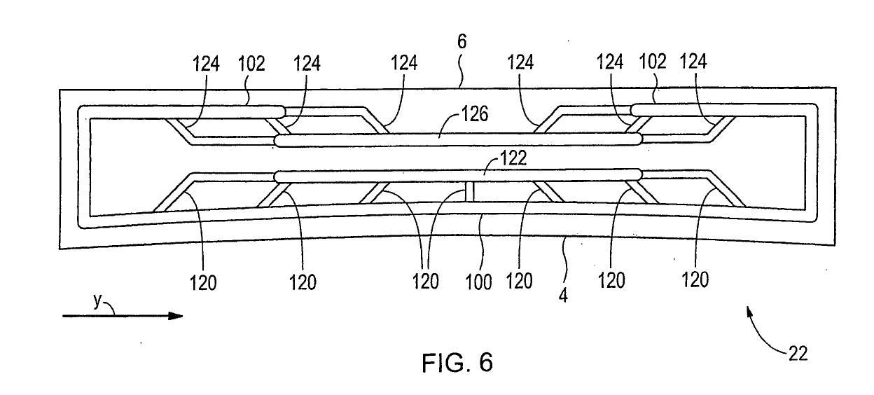

In the exemplary embodiment shown in FIG. 6, the first passage section 100 is connected to a central distributor passage 122 through a plurality of feed passages 120. The feed passages 120 are distributed symmetrically around the center axis and feed fresh cooling fluid F into the first passage section 100 at various locations. Dividing the cooling fluid into a plurality of cold partial-streams reduces the temperature gradient in the transverse direction y along the mirror surface 4. In the same way, the second passage section 102 is also connected to a central collection passage 126 through a plurality of outlet passages 124, likewise, to achieve a shallower temperature gradient on the rear side. Distributor passage 122 and collection passage 126 are located relatively close together so that there is an additional exchange of heat between the cooling fluid flowing in and the cooling fluid flowing out, which makes an additional contribution to homogenization of the temperature gradient between the front and-rear sides of the reflector plate 22.

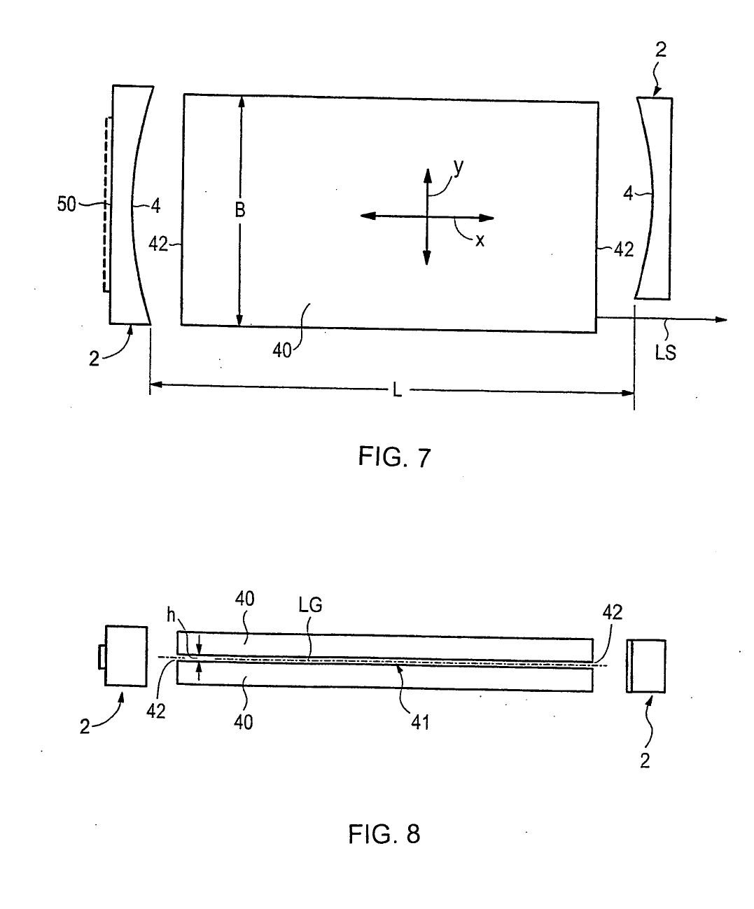

In accordance with FIGS. 7 and 8, the mirrors 2 are used as resonator mirrors for a CO₂ stripline laser. Such a CO₂ stripline laser includes two areally extending plate-like electrodes 40, between which there is a laser gas LG. The electrodes 40 define a narrow discharge space 41, which is only a few millimeters high but has a considerable extent in the longitudinal and transverse directions x, y (typical values for a high-power laser in the kW range are height H≈1-2 mm, length L≈1 m, width B≈0.5 m), and this discharge space is assigned, at each end side 42 the relatively narrow mirror 2, as resonator mirror, which has its main extent in the transverse direction y and through which the cooling fluid flows. In the exemplary embodiment illustrated, this is an unstable resonator of the negative branch, the mirrors 2 of which each have a concavely curved mirror surface 4. One of the mirrors 2 does not extend over the entire width B of the discharge space 41 and, consequently, the laser beam LS generated in the resonator can emerge at its edge with an approximately rectangular beam shape corresponding to the end side 42.

One of the resonator mirrors, in the example, the rear mirror, may, moreover, be provided on its rear side with a heat source 50, which is indicated by dashed lines in the drawing and can be used to compensate for any residual thermal stresses that may occur.

1. A mirror for a laser beam, comprising:
a mirror body having:
a first region under thermal load from the laser beam, said region having a center;
at least one second region not under thermal load from the laser beam; and
at least one cooling passage:
disposed to pass a cooling fluid through said mirror body and cool said first region at least approximately symmetrically with respect to said center of said first region; and
guiding the cooling fluid heated in said first region into said at least one second region to compensate for thermally induced stresses in said mirror body.

2. The mirror according to claim 1, wherein:
said mirror body has:
a mirror surface; and
a rear wall opposite said mirror surface;
the cooling fluid flows in said at least one cooling passage in a direction of flow; and
said at least one cooling passage has:
an internal first passage section disposed adjacent said first region and cooling said first region; and
an internal second passage section disposed downstream of said internal first passage section with respect to the direction of flow of the cooling fluid and is adjacent said rear wall.

3. The mirror according to claim 1, wherein:
said mirror body has:
a mirror surface; and
a rear wall opposite said mirror surface;
the cooling fluid flows in said at least one cooling passage in a direction of flow; and
said at least one cooling passage has, to cool said first region:
an internal first passage section disposed adjacent said first region; and
an internal second passage section disposed downstream of said internal first passage section with respect to the direction of flow of the cooling fluid and is adjacent said rear wall.

4. The mirror according to claim 2, wherein:
said mirror body has:
a center; and
at least one edge;
said at least one cooling passage has:
at least one feed passage fluidically connected to said first passage section; and
at least one outlet passage fluidically connected to said second passage section; and
said at least one cooling passage divides the cooling fluid in said first and second passage sections into at least two partial-streams flowing from said center to said edge and from said edge to said center, respectively.

5. The mirror according to claim 2, wherein:
said at least one cooling passage has at least one internal, lateral connecting passage; and
said firsthand second-passage sections communicate with one another through said at least one internal, lateral connecting passage.

6. The mirror according to claim 2, wherein said at least one cooling passage has at least one internal, lateral connecting passage fluidically connecting said first passage section to said second passage section.

7. The mirror according to claim 2, wherein said first and second passage sections run substantially parallel to at least one of said mirror surface and said rear wall.

8. The mirror according to claim 2, wherein:
said first passage section runs substantially parallel to said mirror surface; and
said second passage section runs substantially parallel to said rear wall.

9. The mirror according to claim 2, wherein:
said mirror body has a center plane running approximately parallel to said mirror surface; and
said first and second passage sections are disposed approximately mirror-symmetrical with respect to said center plane.

10. The mirror according to claim 2, wherein:
said mirror body has a center plane running approximately parallel to said mirror surface; and
said first and second passage sections are disposed approximately mirror-symmetrical with respect to one another, at least over a substantial part of a length thereof, and with respect to said center plane.

11. The mirror according to claim 2, wherein
said at least one cooling passage has symmetrically disposed feed passages; and
said first passage section is fluidically connected to said feed passages.

12. The mirror according to claim 11, wherein;
said at least one cooling passage has outlet passages; and
said second passage section is fluidically connected to said outlet passages.

13. The mirror according to claim 1, wherein:
said mirror body has:
a center plane running approximately parallel to said mirror surface;
a plane of symmetry running perpendicular to said center plane; and
a second cooling passage having a configuration substantially the same as said at least one cooling passage; and
said at least one cooling passage and said second cooling passage are disposed mirror-symmetrically with respect to said plane of symmetry.

14. The mirror according to claim 2, wherein:
said mirror body has:
a center plane running approximately parallel to said mirror surface;
a plane of symmetry running perpendicular to said center plane; and
a second cooling passage having a configuration substantially the same as said at least one cooling passage; and
said at least one cooling passage and said second cooling passage are disposed mirror-symmetrically with respect to said plane of symmetry.

15. The mirror according to claim 13, wherein:
said mirror body has an internal, perpendicular connecting passage; and
said at least one cooling passage and said second cooling passage each communicate with one another through said internal, perpendicular connecting passage.

16. The mirror according to claim 14, wherein:
said mirror body has an internal, perpendicular connecting passage; and
said at least one cooling passage and said second cooling passage each communicate with one another through said internal, perpendicular connecting passage.

17. The mirror according to claim 13, wherein:
said mirror body has an internal, perpendicular connecting passage; and
an internal, perpendicular connecting passage fluidically connects said at least one cooling passage and said second cooling passage.

18. The mirror according to claim 14, wherein:
said mirror body has an internal, perpendicular connecting passage; and
an internal, perpendicular connecting passage fluidically connects said at least one cooling passage and said second cooling passage.

19. A mirror for a laser beam, comprising:
a mirror body having:
a first region under thermal load from the laser beam, said region having a center;
at least one second region not under thermal load from the laser beam; and
at least one cooling passage compensating for thermally induced stresses in said mirror body, said at least one cooling passage:
being disposed to pass a cooling fluid through said mirror body and cool said first region at least approximately symmetrically with respect to said center of said first region; and
guiding the cooling fluid heated in said first region into said at least one second region.

20. A mirror for a laser beam, comprising:
a base plate;
a cover plate;
a first region under thermal load from the laser beam, said region having a center;
at least one second region not under thermal load from the laser beam;
a reflector plate being disposed between said base plate and said cover plate, said reflector plate having:
a mirror surface; and
at least one cooling passage:
disposed to pass a cooling fluid through said mirror body and cool said first region at least approximately symmetrically with respect to said center of said first region; and
guiding the cooling fluid heated in said first region into said at least one second region to compensate for thermally induced stresses in said mirror body.

21. The mirror according to claim 20, wherein said mirror is a resonator mirror for a stripline laser.

22. A resonator mirror for a stripline laser generating a laser beam, comprising:
a base plate;
a cover plate;
a first region under thermal load from the laser beam, said region having a center;
at least one second region not under thermal load from the laser beam;
a reflector plate being disposed between said base plate and said cover plate, said reflector plate having:
a mirror surface; and
at least one cooling passage:
disposed to pass a cooling fluid through said mirror body and cool said first region at least approximately symmetrically with respect to said center of said first region; and
guiding the cooling fluid heated in said first region into said at least one second region to compensate for thermally induced stresses in said mirror body.

23. The resonator mirror according to claim 22, wherein the stripline laser is a CO₂ high-power stripline laser.

24. A stripline laser for generating a laser beam, comprising:
areally extending electrodes defining a discharge space therebetween, said electrodes having at least one end side;
a laser gas disposed between said electrodes; and
a resonator mirror disposed on said at least one end side and having:
a base plate;
a cover plate;
a first region under thermal load from the laser beam, said region having a center;
at least one second region not under thermal load from the laser beam;
a reflector plate being disposed between said base plate and said cover plate, said reflector plate having:
a mirror surface; and
at least one cooling passage:
disposed to pass a cooling fluid through said mirror body and cool said first region at least approximately symmetrically with respect to said center of said first region; and
guiding the cooling fluid heated in said first region into said at least one second region to compensate for thermally induced stresses in said mirror body.

25. The resonator mirror according to claim 24, wherein the stripline laser is a CO₂ high-power stripline laser.
